(19) United States
(12) Patent Application Publication
(10) Pub. No.: US 2002/0157256 A1
(43) Pub. Date: Oct. 31, 2002

(54) Razor head apparatus

(76) Inventor: Chris A. Barone, Trumbull, CT (US)

Correspondence Address: Gregg C. Benson, Pfizer Inc., Patent Department, MS 4159, Eastern Point Road, Groton, CT, 06340, US

(21) Appl. No.: 10/132,904

(22) Filed: Apr. 24, 2002

Related U.S. Application Data
(60) Provisional application No. 60/287,099, filed on Apr. 27, 2001.

(51) Int. Cl. B26B 21/22

(52) U.S. Cl. 30/41; 30/50

(57) ABSTRACT

A razor cartridge is provided that includes a frame, one or more razor blades mounted within the frame, and a guard attached to the frame. The guard is disposed forward of the one or more razor blades. The guard consists essentially of a water-insoluble compliant material and a water-soluble lubricious material.

### CROSS-REFERENCE TO RELATED APPLICATIONS

The present application is a U.S. non-provisional application. This application claims the benefit of U.S. Ser. No. 60/287,099 filed on Apr. 27, 2001, under 35 USC 119(e).

### BACKGROUND OF THE INVENTION

1. Technical Field

This invention relates to razor heads in general, and to razors with guards in particular.

2. Background Information

Modern safety razors include one or more blades disposed within a head that is mounted on a handle. In some embodiments, the head is a disposable cartridge that can be replaced and in other embodiments the combined handle and head are a unitary disposable. A variety of razor head configurations exist, but typically a razor head includes a frame made of a rigid plastic and one or more blades mounted in the frame. The frame includes a seat portion and a cap portion, and the one or more blades are disposed between the cap and the seat. The head further includes a guard disposed slightly below and forward of the blade so that the skin of the shaver encounters the guard prior to encountering the blade. The guard orients the position of the shaver's skin relative to the blade to optimize the shaving action of the blade. Modern safety razors are also known to include one or more comfort strips attached to the head. Comfort strips typically include an insoluble material mixed with a soluble material. In some instances, the soluble material itself facilitates the shaving process, and in other instances one or more shaving aid agents (e.g., lubricating agents, drag reducing agents, depilatory agents, cleaning agents, medicinal agents, etc.) are added to the comfort strip material to further enhance the shaving process.

Because disposable razor heads are mass-produced, the manufacturability of any particular razor and the comfort and performance provided by that razor must be carefully considered. Improvements that benefit razor manufacturability, comfort, and/or performance, significant or subtle, can have a decided impact on the commercial success of a razor. It would be desirable, therefore, to provide a razor that is readily manufacturable, and one that provides desirable comfort and performance.

### DISCLOSURE OF THE INVENTION

It is, therefore, an object of the present invention to provide a razor that is readily manufacturable, and one that provides desirable comfort and performance.

According to the present invention, a razor cartridge is provided that includes a frame, one or more razor blades mounted within the frame, and a guard attached to the frame. The guard is disposed forward of the one or more razor blades. The guard consists essentially of a water-insoluble compliant material and a water-soluble lubricious material.

An advantage of the present invention is that the guard of the present invention provides increased comfort to the shaver. The combination of the water-insoluble compliant material and the water-soluble lubricious material not only provides for the dispensing of a lubricious material forward of the razor blades, but also does so via a compliant member that is able to bend in response to the contour of the skin being shaved. As a result, a more uniform application of lubricant results, thereby creating a more comfortable shave for the shaver.

Another advantage of the present invention stems from the guard's ability to provide a skin alignment and whisker preparation function together with a lubricating function in a compliant form. Prior art razors are known to include a compliant guard and a rigid lubricating strip, independent of one another forward of the razor blade or blades. The rigid lubricating strip is typically disposed between the guard and the razor blade. The compliant nature of the prior art guard allows the guard to bend in response to the contour of the skin being shaved. Yet, the prior art rigid lubricating strip located aft of the compliant guard to some degree counteracts the advantage provided by the compliant guard. The present invention, in contrast, overcomes that problem by providing a compliant guard that integrally includes a water-soluble lubricious material.

Another advantage of the present invention is that the manufacturability of the razor cartridge is appreciably improved. Most prior art razor cartridges utilize a guard that is separate from and independent of a comfort strip. As a result, two separate manufacturing steps are typically required to incorporate those two elements into the razor cartridge or head. A person of skill in the art will recognize the advantages of simplifying the manufacturing steps of a razor, e.g., cost, quality control, etc.

These and other objects, features, and advantages of the present invention will become apparent in light of the detailed description of the present invention.

### BRIEF DESCRIPTION OF THE DRAWINGS

FIG. 1 is a perspective view of a razor.

FIG. 2 is a diagrammatic top view of a razor cartridge.

FIG. 3 is a diagrammatic front view of the razor cartridge shown in FIG. 2.

FIG. 4 is a diagrammatic sectional view of the razor cartridge shown in FIG. 3.

FIG. 5 is a diagrammatic sectional view of the razor cartridge shown in FIG. 3.

FIG. 6 is a diagrammatic sectional view of the guard material having a linear orientation.

### DETAILED DESCRIPTION OF THE INVENTION

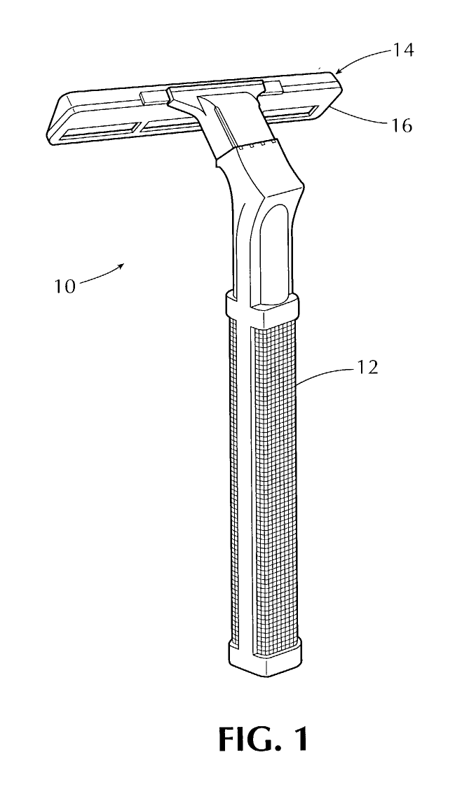

Referring to FIG. 1, a razor assembly (“razor”) 10 includes a handle 12 and head 14 attached to one another. The head 14 can be permanently attached to the handle 12 or it can be removably attached to the handle 12 as a replacement cartridge 16. In both instances, the attachment can be rigid or a pivot-type attachment. To facilitate this detailed description, the present invention will be described in terms of a replaceable cartridge 16. However, the present invention can also assume the form of a unitary razor assembly 10 having a handle 12 and a head 14.

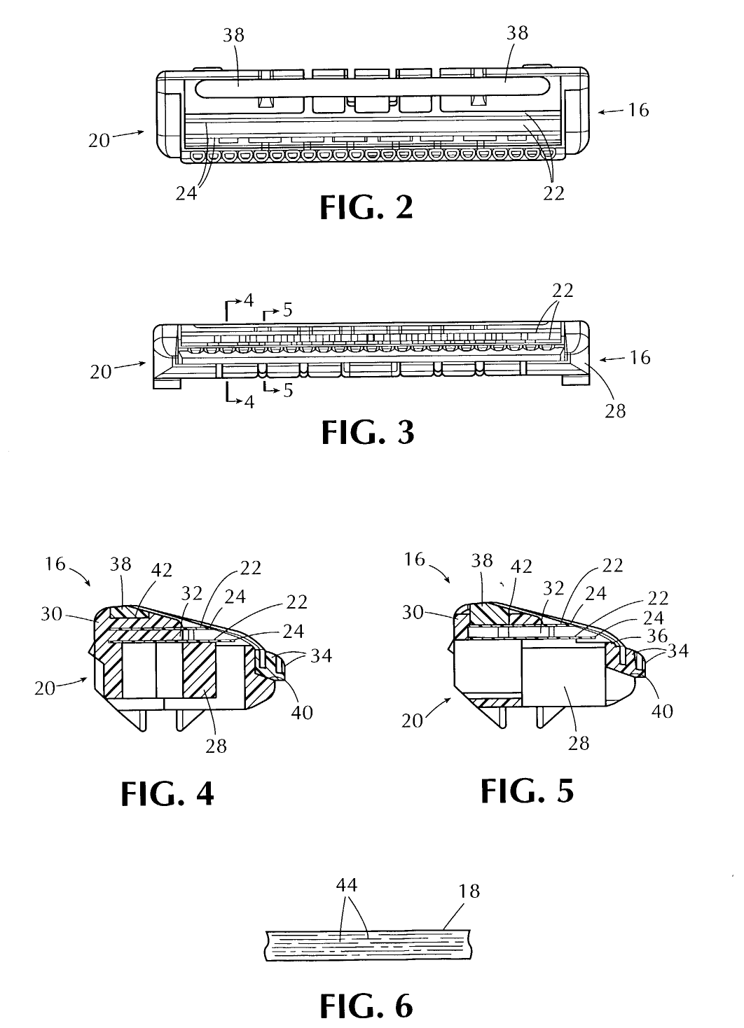

Referring to FIGS. 2-5, the cartridge 16 includes a guard 18, a frame 20, and one or more razor blades 22 mounted within the frame 20. Each razor blade 22 has a cutting edge 24 that extends along the length 26 of the blade 22. The frame 20, which includes a seat 28 and a cap 30, is typically made of a rigid water-insoluble plastic material such as a polystyrene, polypropylene, or an ABS. For those embodiments having a plurality of blades 22, the frame 20 further includes one or more spacers 32 disposed between the blades 22. The terms “forward” and “aft”, as used herein, define relative position between two or more things. A feature “forward” of the blades 22, for example, is positioned so that the surface to be shaved encounters the feature before it encounters the blades 22, assuming that the cartridge 16 is being stroked in its intended cutting direction. Likewise, a feature “aft” of the blades 22 is positioned so that the surface to be shaved encounters the feature after it encounters the blades 22, assuming that the cartridge 16 is being stroked in its intended cutting direction. The guard 18 is attached to the frame 20 forward of the cutting edges 24 of the blades 22.

The guard 18 includes a plurality of ribs 34 and tabs 36 disposed along the length of the adjacent razor blade 22. The guard 18 consists essentially of a water-insoluble compliant material and a water-soluble lubricious material. The compliant material and the lubricious material are substantially uniformly mixed together. The compliant material provides a support structure for the lubricious material. The relative percentages of the compliant material and the lubricious material can vary to accommodate different materials and applications. The percentages are limited, however, by the function they provide, e.g., the guard 18 preferably contains sufficient lubricious material so that an acceptable amount of lubricious material can be exuded for the anticipated life of the cartridge 16. It is our experience that a mixture that consists essentially of the compliant material and the lubricious material can vary from about 30% lubricious material and 70% compliant material, to about 90% lubricious material and 10% compliant material. It is our further experience that it is preferred to have a guard 18 that consists essentially of materials in the range of about 50% lubricious material and 50% compliant material, to about 80% lubricious material and 20% compliant material. The most preferred guard material mixture range is from about 60% lubricious material and 40% compliant material, to about 75% lubricious material and 25% compliant material. It should be noted that the present guard 18, which consists essentially of the aforesaid lubricious and compliant materials, may include additional materials in small quantities that do not materially effect the function of the compliant and lubricious materials (e.g., shaving aids, etc.; see below).

Several different types of compliant materials are acceptable for the present application including, but not limited to, thermoplastic elastomers, thermoplastic vulcanates, thermoplastic urethanes, thermoplastic olefins, silicon rubbers, etc. It is our experience that a thermoplastic elastomer is particularly well suited to the present invention application. An example of such a thermoplastic elastomer is VYRAM® 9211-45W-9060. VYRAM® is a product of Advanced Elastomer Systems, LP of Akron, Ohio, U.S.A.

Several different types of lubricious materials are acceptable for the present application. It is our experience that a hydrophilic polymer such as polyethylene oxide or polyvinylpyrrolidone is particularly well suited to the present invention application. An example of such a polyethylene oxide is POLYOX®. POLYOX® is a product of Union Carbide Corporation of Danbury, Conn., U.S.A.

In some instances, a shaving aid may be added to the guard mixture to further enhance the performance and/or comfort of the shave. A variety of shaving aids are known and can be used in this application. Some shaving aids can be added directly to the guard mixture and others preferably are microencapsulated first with a water-soluble material. Examples of shaving aids include, but are not limited to, lubricating agents, drag reducing agents, depilatory agents, cleaning agents, and medicinal agents.

In some cartridge 16 embodiments, an independent comfort strip 38 is attached to the frame cap 30, aft of the razor blades 22. Typically, the comfort strip 38 includes a water-insoluble rigid matrix material combined with a shaving aid encapsulated within a water-soluble polymer. Examples of acceptable shaving aids include, but are not limited to, lubricating agents, drag reducing agents, depilatory agents, cleaning agents, and medicinal agents.

In the first step of the manufacturing process of the present invention cartridge 16 or razor assembly 10, the blades 22 are positioned into a forming mold (not shown), and a molten plastic is injected into the mold to form the seat 28, cap 30, and spacer portions 32 of the frame 20, thereby mounting and securing the blades 22 within the frame 20. The mold is shaped to create a plurality of surfaces 40 in the frame 20 to which the guard 18 can be secured. The mold used to manufacture the cartridge 16 embodiment shown in FIGS. 2-5 is also shaped to form a channel 42 in the cap portion 32 of the frame 20 for receiving a comfort strip 38. As stated above, the frame 20 is typically formed from a water-insoluble plastic material (e.g., polystyrene, polypropylene, ABS, etc.) that thermosets into a rigid form.

The guard 18 is created in an independent second step, although the process used can be an injection molding like that used in the first step. The material that forms the guard 18 is prepared prior to being melted and pumped into the molds. Compliant materials such as a thermoplastic elastomer are typically distributed in pellet form. Lubricious materials such as a polyethylene oxide, in contrast, are typically distributed in powder form. It is our experience that the best manufacturing process for the present invention guard 18 involves an initial step of changing the form of one or both guard materials so that they are in common form, e.g., both in a powder form, at a certain particulate size. Once the two essential materials are in common form, they are mixed to create a uniform dispersion. The mixed material is then melted and injected into a mold containing the previously formed frame 20. The molten guard material mix bonds with and attaches to the surfaces 40 in the seat portion 28 of the frame 20, consequently creating a unitary structure.

In those embodiments that include the addition of a shaving aid to the guard 18, the shaving aid is preferably prepared in the common particulate size and is mixed with the compliant and lubricious materials to create the aforesaid uniform dispersion prior to melting. The steps of forming the guard 18 and the cartridge 18 overall are then followed as described above.

In those embodiments that include a comfort strip 38 disposed in the cap 30, a third step in the manufacturing process is used to form and attach the comfort strip 38 to the cap 30. The materials of the comfort strip 38 are disclosed above. The method of forming a comfort strip 38 is known in the art and will therefore not be discussed in detail here.

In an alternative manufacturing process, the present invention guard 18 can be formed using an extrusion process. Like above, the compliant material and the lubricious material are placed into common form (e.g., common particulate size) and are mixed to achieve a mixture with a substantially uniform dispersion of the two materials. The mixture is processed through an extruder that works the mixture into a molten form and subsequently passes it through a die. The die gives the extruded material a particular cross-sectional geometry. The extruded guard material is then cut to length and attached to the frame 20 of the cartridge 16 using mechanical means (e.g., tabs, etc.) or chemical means (e.g., an adhesive or bonding agent, etc.). Forming the guard 18 by an extrusion process gives the guard material an advantageous lengthwise extending linear orientation 44 as can be seen in FIG. 6. It is our experience that the linear orientation 44 of the lubricious material within the guard 18 provides an improved dispersion of lubricant along the length of the guard 18, and consequent improved comfort during the shave.

Although this invention has been shown and described with respect to the detailed embodiments thereof, it will be understood by those skilled in the art that various changes in form and detail thereof may be made without departing from the spirit and scope of the invention.

What is claimed is:

1. A razor cartridge, comprising:
a frame;
one or more razor blades attached to the frame; and
a guard attached to the frame, wherein the guard is disposed forward of the one or more razor blades; and
wherein the guard consists essentially of a water-insoluble compliant material and a water-soluble lubricious material, thereby enabling the guard to be compliant and lubricious when exposed to water.

2. The razor cartridge of claim 1, wherein the frame includes a seat portion and a cap portion, and the guard is attached to the seat portion of the frame.

3. The razor cartridge of claim 1, wherein the frame consists of a material that is different from the materials of the guard.

4. The razor cartridge of claim 1, wherein the frame consists of a water-insoluble rigid material.

5. The razor cartridge of claim 4, wherein the guard is formed by an injection molding process.

6. The razor cartridge of claim 5, wherein the frame is formed by an injection molding process.

7. The razor cartridge of claim 6, wherein the water-insoluble compliant material is a thermoplastic elastomer.

8. The razor cartridge of claim 7, wherein the water-soluble lubricious material is a hydrophilic polymer.

9. The razor cartridge of claim 8, wherein the water-soluble material is a polyethylene oxide.

10. The razor cartridge of claim 4, wherein the materials of the guard have a lengthwise extending linear orientation.

11. The razor cartridge of claim 10, wherein the guard is formed by an extrusion process.

12. The razor cartridge of claim 11, wherein the frame is formed by an injection molding process.

13. The razor cartridge of claim 12, wherein the water-insoluble compliant material is a thermoplastic elastomer.

14. The razor cartridge of claim 13, wherein the water-soluble lubricious material is a hydrophilic polymer.

15. The razor cartridge of claim 14, wherein the water-soluble material is a polyethylene oxide.

16. The razor cartridge of claim 1, wherein the guard is comprised of the water-soluble lubricious material and the water-insoluble compliant material in the range of between about 30% lubricious material and 70% compliant material, to about 90% lubricious material and 10% compliant material.

17. The razor cartridge of claim 16, wherein the guard is comprised of the water-soluble lubricious material and the water-insoluble compliant material in the range of between about 50% lubricious material and 50% compliant material, to about 80% lubricious material and 20%, compliant material.

18. The razor cartridge of claim 17, wherein the guard is comprised of the water-soluble lubricious material and the water-insoluble compliant material in the range of between about 60% lubricious material and 40% compliant material, to about 75% lubricious material and 25% compliant material.

19. A razor assembly, comprising:
a handle; and
a cartridge having a guard, a frame, and one or more razor blades attached to the frame;
wherein the guard is attached to the frame at a position forward of the one or more razor blades; and
wherein the guard consists essentially of a water-insoluble compliant material and a water-soluble lubricious material, thereby enabling the guard to be compliant and lubricious when exposed to water.

20. The razor assembly of claim 19, wherein the frame consists of a material that is different from the materials of the guard.

21. The razor assembly of claim 19, wherein the frame consists of a water-insoluble rigid material.

22. The razor assembly of claim 21, wherein the guard is formed by an injection molding process.

23. The razor assembly of claim 22, wherein the frame is formed by an injection molding process.

24. The razor assembly of claim 23, wherein the water-insoluble compliant material is a thermoplastic elastomer.

25. The razor assembly of claim 24, wherein the water-soluble lubricious material is a hydrophilic polymer.

26. The razor assembly of claim 25, wherein the water-soluble material is a polyethylene oxide.

27. The razor assembly of claim 20, wherein the materials of the guard have a lengthwise extending linear orientation.

28. The razor assembly of claim 27, wherein the guard is formed by an extrusion process.

29. The razor assembly of claim 28, wherein the frame is formed by an injection molding process.

30. The razor assembly of claim 29, wherein the water-insoluble compliant material is a thermoplastic elastomer.

31. The razor assembly of claim 30, wherein the water-soluble lubricious material is a hydrophilic polymer.

32. The razor assembly of claim 31, wherein the water-soluble material is a polyethylene oxide.

33. The razor assembly of claim 19, wherein the guard is comprised of the water-soluble lubricious material and the water-insoluble compliant material in the range of between about 30% lubricious material and 70% compliant material, to about 90% lubricious material and 10% compliant material.

34. The razor cartridge of claim 33 wherein the guard is comprised of the water-soluble lubricious material and the water-insoluble compliant material in the range of between about 50% lubricious material and 50% compliant material, to about 80% lubricious material and 20% compliant material.

35. The razor cartridge of claim 34, wherein the guard is comprised of the water-soluble lubricious material and the water-insoluble compliant material in the range of between about 60% lubricious material and 40% compliant material, to about 75% lubricious material and 25% compliant material.
